(19) United States
(12) Patent Application Publication
(10) Pub. No.: US 2014/0058709 A1
(43) Pub. Date: Feb. 27, 2014

(54) STRUCTURAL HEALTH MANAGEMENT SYSTEM AND METHOD BASED ON COMBINED PHYSICAL AND SIMULATED DATA

(71) Applicants: Júlio César Machado Viana, Braga (PT); Gustavo Alexandre Rodrigues Dias, Matosinhos (PT); Paulo Jorge Da Rocha Soares Antunes, Braga (PT); Manuel Alexandre Vieira Baptista, Vila Nova de Gaia (PT); Nelson Jadir Mendes Ferreira, Braga (PT)

(72) Inventors: Júlio César Machado Viana, Braga (PT); Gustavo Alexandre Rodrigues Dias, Matosinhos (PT); Paulo Jorge Da Rocha Soares Antunes, Braga (PT); Manuel Alexandre Vieira Baptista, Vila Nova de Gaia (PT); Nelson Jadir Mendes Ferreira, Braga (PT)

(73) Assignee: CRITICAL MATERIALS, LDA., Caldas Das Taipas (PT)

(21) Appl. No.: 14/002,090

(22) PCT Filed: Feb. 28, 2011
(86) PCT No.: PCT/PT11/00004

§ 371 Date: Nov. 4, 2013

(51) Int. Cl. G06F 17/50

(52) U.S. Cl. CPC G06F 17/5009; G06F 17/5018
USPC 703/2; 703/6

(57) ABSTRACT

System and method to manage the structural integrity of critical systems for decision-making support actions based upon their condition, in a structural health management system, analysing information from physical sensors through a computational model (101) of the system. The invention comprises an optimal sensor placement method, a data acquisition system with multi-sensor capability mounted/embedded in the critical system (100), a sampling algorithm for balanced compacted information flow from sensor to storage, a data exchange channel (12) linking the physical module (100) with the virtual one (101), a simulated model of the components/structures combined with the adequate solver for the actual physics involved on the problem and an optimization tool, a database to store data and manage results, a decision module for diagnostics and prognostics of the component/structure integrity status, and a data treatment and visualisation tools (22). These modules support decision-making actions (11, 23, 25) and new components/structures design (18).

### TECHNICAL FIELD OF THE INVENTION

The invention relates to structural health monitoring and assessment of structural integrity of critical systems and its management, namely a system and method for these purposes.

### SUMMARY

Specifically, physical sensors (e.g. acceleration, deformation, temperature, humidity) are placed in a structural component/structure using an optimization procedure. The sensors are linked to a data acquisition system, complemented with sampling procedures and signal processing operations. The acquisition system is implemented within an adequate hardware platform (physical module) enabling the storage and low level processing of data. Sensor fault diagnosis is performed to check sensor sanity. The information taken from the physical reality defines an input to a simulated platform (virtual module) that is representative of the behaviour of the component/structure in service. The results of the simulated platform will define a basis for diagnosis of the structural status and provides a mean of structural prognosis, providing a tool for analysing and predicting the structural integrity of the component. This information supports decision-making actions based on the structural health of the critical system and new components/structures design methodologies. Furthermore, the combination of real (from sensor) and simulated data allows of the use of a reduced number of sensors, as simulations are able of giving system response with higher spatial resolution and with additional information. The reduced number of sensors is crucial for a less complex, lightweight and less costly system. The close integration of the invention, between the simulated model, the sensor placement and the real-life system performance monitoring through continuous analysis and update of the previously built simulated model, creates a highly robust, and efficient system whether in terms of sensor placement, sensor malfunction or accuracy of results.

Structural health management can be performed on a single component, single critical system or group of critical systems. It is an object of the invention to provide a new improved method for the structural health management of critical systems, supporting decisions-making actions thereafter.

The present invention provides a means for diagnosis and prognosis of the structural integrity of components/structures, which can be integrated in maintenance programs enabling maintenance engineers to analyse their structural status and to schedule interventions accordingly, thus reducing costs.

The present invention provides a forecasting tool based on the prognosis of material degradation and evolution of intrinsic damage enabling knowledgeable decisions on repairing and substitution of parts, supporting logistics actions and reducing costs. The structural status prognosis provides also means for better and safer planning of new operations of the critical system.

The present invention provides means for managing the structural health of a set of critical systems, allowing an integrated and more efficient management of a fleet of critical assets.

The present invention provides a means for documenting the loading applied during the lifetime of the component/structure/system and its behaviour. This information is particularly helpful for structural engineers designing of new systems.

The invention describes a system for managing structural health based on combined physical and simulated integrity data of a critical structure (2), which comprises:
a physical module (100) placed in said structure (2), which comprises a sensor network (1, 3, 4) mounted or embedded in said structure (2), a hardware platform (6) comprising a data acquisition (7) and sampling and signal processing (8) sub-modules with multi-sensor capability, and an interface (5) to the hardware platform (6);
a virtual module (101), which comprises a simulated representative virtual model (24) of the structure (2) combined with a suitable solver (15) able to reproduce the behaviour of the structure (2), and its components, based on the physical information gathered from the physical module (100);
wherein said simulated model (24) was previously established when defining the Optimal locations of said sensors.

A preferred embodiment further comprises:
a data storage sub-module (9) in the physical module (100);
a database (17) in the virtual module (101) storing and managing data, real or simulated;
a decision sub-module (19) comprising diagnostics (20) and prognostics (21) sub-modules of the structure (2).

In a preferred embodiment the sampling sub-module (8) will trigger data gathering intervals and data acquisition frequency, based on predefined values or on a sporadic but relevant event.

In a preferred embodiment, signal processing operations are able to be performed in the sampling sub-module (8), in particular averaging, filtering, time-to-frequency transforms, or de-noising.

In a preferred embodiment the solver sub-module (15) comprises an analytical or a numerical solution through a metamodel approximation, a Finite Element Method—FEM, calculator, Finite Volume Method—FVM, calculator, Boundary Element Method—BEM, calculator, or a meshless structural calculator.

In a preferred embodiment both physical (100) and virtual (101) modules are both mounted or embedded in said structure (2) and connected by a suitable data connection (12).

In a preferred embodiment the virtual module (101) is mounted away from said structure (2), and connected to the physical (100) module by a suitable data connection (12).

In a preferred embodiment the data connection 12) between the physical (100) and virtual (101) modules is asynchronous.

A preferred embodiment further comprises an output layer sub-module (22), connected to the diagnostic (20) and prognostic (21) sub-modules on the integrity of the structure (2).

In a preferred embodiment the simulated representative virtual model (24) of the structure (2) further comprises previously or regularly obtained interrogative procedure data.

A preferred embodiment further comprises an interface for data exchange (10) with the exterior of the system.

In a preferred embodiment the virtual module (101), comprises an interface for data exchange (13) with exterior, a data translation (14) tool.

In a preferred embodiment wherein the virtual module (101), comprises an optimization tool (16) able to support the damage diagnosis tool (20).

A preferred embodiment further comprises the integrated and simultaneous management of the structural health of several structures/components of a critical system.

A preferred embodiment further comprises the integrated and simultaneous management of the structural health of a set of critical systems.

The present invention also describes a method for managing structure health based on combining physical and simulated integrity data of a critical structure (2) comprising the steps of:
acquiring (7), sampling and signal processing (8) physical integrity data from a plurality of sensors (1, 3, 4) mounted or embedded in the structure (2); calculating and solving (15) a simulated representative virtual model (24) of the structure (2) reproducing the physical status of the structure (2), and its components; combining real data from the two previous steps through an optimization algorithm for diagnosing—detecting, locating and evaluating the severity—of material or structure damage,
wherein said sensors (1, 3, 4) position was previously established by an optimization method,
wherein real sensor (1, 3, 4) responses are checked for sensor fault detection before being fed to the simulated virtual model (24),
wherein said simulated model (24) was previously established when defining the optimal locations of said sensors (1, 3, 4).

In a preferred embodiment the sensor fault detection is performed in a physical module (100) at the data acquisition system level (17), or it is performed in a virtual module (101) at the data translation level (13), or in both physical and virtual modules (100) and (101), respectively.

In a preferred embodiment the sensor (1, 2, 4) positioning on said structure (2) comprises any suitable optimization methodology that minimizes their number, whilst maximizing their sensing capability, being based on the simulated model (24) with a solver (15) representative of the material/structure.

In a preferred embodiment the sensor placement optimises the response of the sensor network to excitation, over a range of frequencies, such that an entire, or the maximum, or a predefined set of vibration modes is captured.

A preferred embodiment further comprises the steps of:
storing (9) the acquired (7) and sampled (8) data; detecting sensor malfunctions and damages in the physical module (100) at the data acquisition level (7) or/and at the virtual module (101) at the data translation level (14), before inputting data into the RVM sub-module (24); translating, to a suitable format for input into the simulated model (24), the acquired (7), sampled (8) and verified data;
determining diagnosis (20) and prognosis (21) of the structure (2) based on said simulated model (24); outputting (22) said diagnostics (20) and prognostics (21) of the structure (2).

In a preferred embodiment the sampling sub-module (8) will trigger data gathering intervals and data acquisition frequency, based on predefined values.

In a preferred embodiment the sampling sub-module (8) will trigger data gathering intervals based on relevant events.

In a preferred embodiment simple signal processing operations are performed in the sampling sub-module (8), in particular averaging, filtering, time-to-frequency transforms, de-noising.

In a preferred embodiment a sensor fault detection tool is used for checking sensor sanity, issuing warnings or stopping further actions in the case of sensor malfunctioning.

In a preferred embodiment the solving (15) of the simulated model (24) comprises an analytical solution or an approximated numerical solution based on metamodel approximation, a Finite Element Method—FEM, a Finite Volume Method FVM, Boundary Element Method—BEM, or a meshless method.

In a preferred embodiment the data communication (12) between the acquired (7) and sampled (8) physical data and the representative virtual model (24) of the structure (2) is asynchronous, with said physical data being collected in data storage (9) over a mission or predefined time period and then being transferred into the simulated model (24).

In a preferred embodiment the data communication (12) between the acquired (7) and sampled (8) physical data and the representative virtual model (24) of the structure (2) is synchronous, with said physical data being transferred into the simulated model (24) in a substantially continuous fashion.

A preferred embodiment further comprises an interrogative method for excitation of the structure (2) and reading of the sensor (1, 3, 4) responses.

In a preferred embodiment an output layer sub-module (22), delivers the information from the diagnostic (20) and prognostic (21) sub-modules on the integrity of the structure (2).

In a preferred embodiment an integrated and simultaneously management of the structural health of several structures/components of a critical system is performed.

In a preferred embodiment an integrated and simultaneously management of the structural health of a set of critical systems is performed.

### BACKGROUND

Within the context of this invention, the expression “critical system” is understood to mean a system or sub-system having one or more mechanical or structural components/structures whose integrity is critical for its performance and safety. Critical systems of this type exist in a great variety of fields, such as for example, the aeronautics, space, maritime, surface transports and infrastructures industries.

Within the context of this invention, the expression “damage diagnostic” is understood to mean the detection of structural or material damage, its location and quantification of its severity.

Modern critical systems are designed within the trade-off of carrying high loads at low weight. Usually the maximum loads and the allowable stresses and strains are defined applying normative instruments that reflect the actual state-of-art of the particular field of structural engineering. Although, significant progress has been done in the near past in design methodologies for advanced materials, the development procedures are based on normative approaches for load determination and analysis followed by large testing programs. Furthermore, even with the previous approach, inspection and maintenance actions are implemented to monitor the structural health of the system, in order to assure high levels of dependability. The maintenance programs are established a priori, based on time estimates and best practices. These often lead to procedures that treat components, which have different importance in the overall behaviour, as equals, with strong impact on the cost of a maintenance program. The normative on the load determination side establishes a safety level that normally collides with a lightweight design of the structure. These norms can be relaxed in the future if there are suitable monitoring procedures that ensure equivalent safety levels. Also suitable monitoring procedures, even when do not imply the relaxation of normative constrains, can be used to extend the inspection intervals on the maintenance programs, with a significant economic impact on the total cost ownership of the critical system.

The monitoring combined with diagnosis and prognosis tools are of paramount importance for critical systems that failure in service would imply its catastrophic collapse. Presently, however, determinations of structural integrity are generally estimated by assuming loading parameters such frequency and maximum loading in order to estimate the structure life. These estimates will generate maintenance protocols, defining inspection intervals and prospective interventions. The inspections are usually performed using interrogation schemes. These are based on procedures of comparing a baseline response representative of a non-degraded behaviour with the actual response, which result is related with the degradation of load carrying capability. Some of these schemes enable the localization of structural flaws and prognostic of residual life. However, an external standard stimulus is needed to load the structure and to compare the response with a baseline solution. More often, for the above mentioned procedure, a sequence of inspection, disassembly, instrumentation and testing tasks are performed. The procedures are valuable for analysis of the structural health, but fail to address an important issue, such as minimizing the necessity of inspections and disassembly operations. Moreover, for the above mentioned procedure, a high number of sensors are installed on the structure/component and excited. This is required in order to have a high spatial resolution and hence a more precise damage diagnostic. This high number of sensors is not compatible with a highly efficient structural health monitoring system, mainly if the sensor network is permanently installed in the structure/component. A high number of sensors, and required cabling, introduces a higher weight into the critical system. A sensor network with a high number of sensors takes more time to install and it is an additional system to inspect and maintain. A high number of sensors generates a high volume of information to process and analyse that may not be relevant in all the cases. A highly efficient structural heath monitoring systems requires therefore the minimal number of sensors.

The present invention provides a new method to analyse the structural health of critical systems, based on a combined approach of physical sensing and simulated modelling and an integrated software tool, directed to overcoming, or at least reducing the effects of one, or more, of the problems set forth above.

Prior health management systems and methods¹ for aircrafts use several information sources (from data sources such as data from flight, system performance, physical sensor and built-in-test/built-in-test equipment), a condition analysis and management system for monitoring the data sources, an information controller for acquiring and processing the data sources and a diagnostic/prognostic reasoner for fusing the collected datasources. Diagnostic/prognostic reasoners use only real information sources to indicate faulty conditions of components. Furthermore, these systems only consider a single system/vehicle and do not provide a global overview of the fleet status (diagnostic and prognostic). ¹EP1455313A1, September 2004 (Kent et al.)

Prior monitoring, diagnosis and prognosis systems and methods² use hybrid model-based diagnostic methodologies. Diagnostic is based on a combination of analytical models and graph-based dependency models to enhance diagnostic performance. The adopted model-based method relies on mathematical analytical models mainly derived from a control theory approach and is suitable for fault diagnosis/prognosis. These models, although based on the cause-effect dependences of the system, do not consider the involved physic phenomena related to the behaviour of the material/structure. No simulated data is used. Furthermore, this approach applies only to a single system/vehicle and do not provide a global status overview of a group of systems. ²US7260501B2, August 2007 (Pattipatti et al.))

Prior structural health management systems of an apparatus³ (e.g., from aircrafts) use sensor data and baseline comparison approaches (e.g. damage estimate baseline of a component, which can be successively updated) for damage estimation. In this type of data-driven approach no simulated data is used, reducing the information available from the system, and limiting or making cumbersome the structural health diagnosis. Although interfacing with inspection and maintenance systems, this approach applies only to a single system/vehicle and do not provide a global status overview of a group of systems. ³US2006/0259217 A1, November 2006 (Gorinevsky et al.)

Prior structural health management systems of mobile platforms (e.g., aircraft) include a pre-processor, a structure and a SHM system⁴. Flight parameters and load sensors are used to feed the SHM system that calculates loads. SHM is also able of detecting impacts. The SHM system communicates with a maintenance information system or with an integrated vehicle health management, IVHM, system. The operation of SHM is not detailed, damage diagnostic and prognostic methods not being supported by physical based models or simulated data. Sensors are located arbitrarily near selected components, their position not being optimised. Although interfacing with inspection and maintenance systems and IVHM system, this approach applies only to a single system/vehicle and do not provide a global overview of a group of systems. ⁴US2006/0004499 A1, January 2006 (Trego et al.)

In all previous examples, no tool for optimal placement of sensors is adopted. Normally, this requires the use of a high number of sensors or results in less accurate damage diagnosis. In all previous examples, no tool for sensor fault detection is used. Normally, this results in a less accurate damage diagnosis or in a high number of false positives. In all previous examples, no integration of real and simulated data is performed. Normally, this makes difficult an efficient damage diagnosis (damage detection, location and severity) and requires the use of a high number of sensors for improved diagnosis. In all previous examples, structural health management is performed in a single asset/structure and not simultaneously for a set of assets and structures. Normally, this implies a low level of aggregation of information and in a higher difficulty in managing a fleet of assets. In prior structural health management systems, and representatively in all previous examples, no integration of methodologies, methods, algorithms, tools and data is done. Normally, this entails a higher difficulty on deploying and operating a structural health management system. This also entails a less efficient, more difficult and costly management of a fleet of assets.

### General Description of the Invention

The present invention relates to a system and method to analyse the structural integrity of critical systems for decision-making support based upon their condition, which is integrated in a structural health management system. The method combines a procedure for reading and analysing information from physical sensors with a simulated computational model of the components/structures of the critical system. The synergy between both real and simulated data allows for the use of a reduced number of sensors and a more accurate assessment of the health condition of the structure/component. The invention comprises an optimal sensor placement algorithm, a data acquisition system with multi-sensor capability mounted/embedded in the critical system, a sampling algorithm and signal processing operations enabling a balanced and compacted information flow from sensor to storage, a sensor fault detection method, a simulated model of the components/structures combined with the adequate solver for the actual physics involved on the problem, data treatment tools and visualisation, a database tool to store data and manage results with a comprehensive behaviour history, and decision modules for diagnostics and prognostics of the component/structure integrity status. These modules support decision-making actions based on the structural health of the critical system and new components/structures design methodologies. The above referred tools are built-in within one software application enabling the integrated flow of information from physical (on-structure) to simulated (on computer) platforms and an integrated structural health management.

The present invention relates to a structural health management system that integrates in a structured and compacted mode several methods that supports decision-making actions to be taken based upon their structural condition.

A method is provided that enables the analysis of structural health and evaluation of structural integrity of components/structures of critical systems.

This method of analysis is accomplished through the use of information gathered from sensors (physical quantities such as acceleration, deformation, temperature) applied on the critical system and computed data from simulated analysis.

At the design stage of the SHM system, the sensors positions are defined using a suitable optimization methodology that minimizes their number, whilst maximizing their sensing capability. As an example, the sensor placement algorithm can be based on the optimization of the sensor response (e.g., acceleration, strain) over a range of frequencies so they capture the entire/maximum set of vibration Modes of the structure. For this, the vibration modes are combined by:

$${U}_{t} = {\prod }_{mode = 1}^{n - 1} {X}_{t} ( m ) f ( m ) {X}_{t} ( m + 1 ) f ( m + 1 )$$

where, Uₜ is the combined positioning variable (e.g., acceleration, strain), m is the mode shape number, xₜ is the variable to be monitored, and f are mode shapes weighting functions. The positions of maximum values of Uₜ are the optimal locations for sensors. Other algorithms for optimal positioning of sensors may be incorporated.

The sensor measurements are channeled through a data acquisition system and recorded for storage. The activation of the acquisition process is controlled by a sampling algorithm and signal processing operations are used to calculate representative values of the variables measured. Sensor fault detection may be performed at the data acquisition level, and warnings/errors will be issued. All the above described features constitute an integrated physical module, enabling the connection with sensors, the recording of values and the interconnection with exterior world. The information gathered is stored on the hardware memory or immediately transmitted for an external data recording hardware. This information can be transferred to a computer using data exchange procedures such cable, wireless or data storage devices (12).

The experimental data received on a computer is translated to a suitable form. Data is further conveniently and adequately processed. Sensor fault detection may be also performed at this level, where warnings/errors are issued. These data may be then used as loading on a representative simulated model of the component/structure. This representative virtual model reconstructs the strain and stress fields for the overall geometry from the load inputs. The experimental data is compared with computed one that, combined with suitable optimization methodology, will allow predicting material degradation and performing the damage diagnostic of the component/structure. A database tool will be used to store the results of the diagnostic of the representative simulated model and it permits a basis for structural prognosis. All the above described features are integrated in a virtual module, supported in a computer application. It enables the connection with the physical world, performing structural health diagnostic and prognostic, data processing and visualization, systems health management and connection with other decision-making support tools.

This approach is not material dependent defining a general method for structural health monitoring.

The method can work in an asynchronous or synchronous mode. In the former case, data is collected in the physical module over a mission or predefined long time period. It is then transferred into the virtual module where several tasks are performed asynchronously (off-time): data monitoring, damage diagnostic and prognostic, and support decision-making actions, as above described. In the second case, data is collected in the physical module during a predefined short time period, therefore in a substantially continuous fashion, being then transferred into virtual module that performs immediately (on-time) data monitoring, damage diagnostic and prognostic, systems health management and support decision-making actions, as above described.

The method can work locally or remotely. In the former case, the physical and virtual modules are both installed in the critical system (on-site). In the second case, the physical module is installed on the critical system (on-system) and the virtual module is located away (off-system) from the critical system (e.g., ground station, control station).

The method can work with in-service excitation of the sensor network coming from the operational use of the system or with an interrogation imposed by a mounted apparatus that is able of exciting the sensor network. In the former case, the readings from the sensors are taken during operation of the system during its in-service usage. In the second case, the structure/component must be coupled with an excitation apparatus that induces the response of the sensors. The system is loaded when not active in service (static status) by this excitation apparatus. This latter can be of several types: a hammer (instrumented or not) for inducing a local load; an attached mechanical system (mounted actuators instrumented or not) inducing a vibration spectra or a static load (hydraulic, electromechanical; piezoelectric); a blown loading.

The physical module is installed in each critical system, in one or more component/structures/sub-systems. More than one critical system can be deployed. The virtual module can deal with one critical system or a group of critical systems, allowing integrated health management of a set of critical systems.

Typical embodiments of the present inventions can be depicted by aeronautic and energy sector applications. An aircraft represents a critical structural system to manage. This system has several critical structures/components that are crucial for its performance and safety. Illustrative examples of structures/sub-systems are wings and wing box, fuselage, empennage, engines, landing gear. Such structures are composed of critical components and their connections. A set of aeronautic systems can be managed—a part or an entire fleet. In the energy sector, a wind turbine generator represents a critical structural system to manage. This system has several critical structures/components that are crucial for its performance and safety. Illustrative examples of structures are the turbine, nacelle, tower, foundations/footing/mooring structures. Such structures are composed of critical components and their connections (blade, rotor, hub, gearbox, shafts, jacket, pillars, hulls, between others). A set of aeronautic systems can be managed—a part or entire farm.

The various features and advantages of this invention will become apparent to those skilled in structural analysis following the detailed description of the currently preferred embodiment. The drawings that accompany the detailed description will be briefly described as follows.

### DESCRIPTION OF THE FIGURES

The following figures provide preferred embodiments for illustrating the description and should not be seen as limiting the scope of invention.

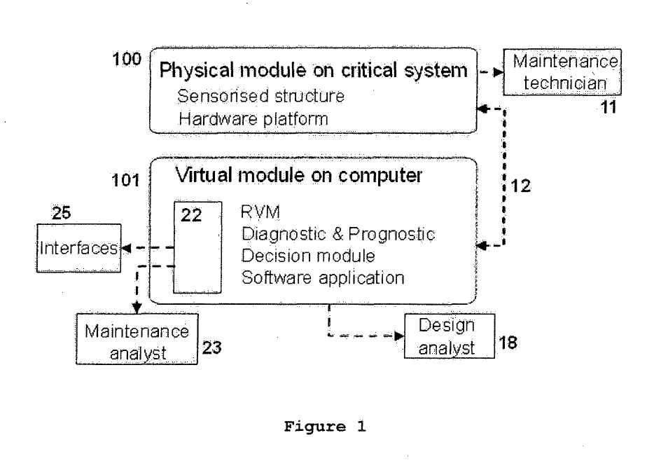

FIG. 1 is a schematic representation of the structural health management system and method according with this invention, where:
100—represents a physical module on critical system, comprising a structure/component instrumented with a multi-sensor network (sensorised structure) and a hardware platform.
101—represents a virtual module on computer, comprising RVM—representative virtual modules of the structure, methods for optimal positioning of sensors, methods for sensor fault detection, models and methods for damage diagnosis and prognosis, a decision-making support tool, a structural health management tool, a database and a software application.
22—represents an output layer, comprising a graphical user interface (GUI)
12—represents a support for data exchange
25—represents interfaces of (101) with other systems (logistics, maintenance, mission planning)

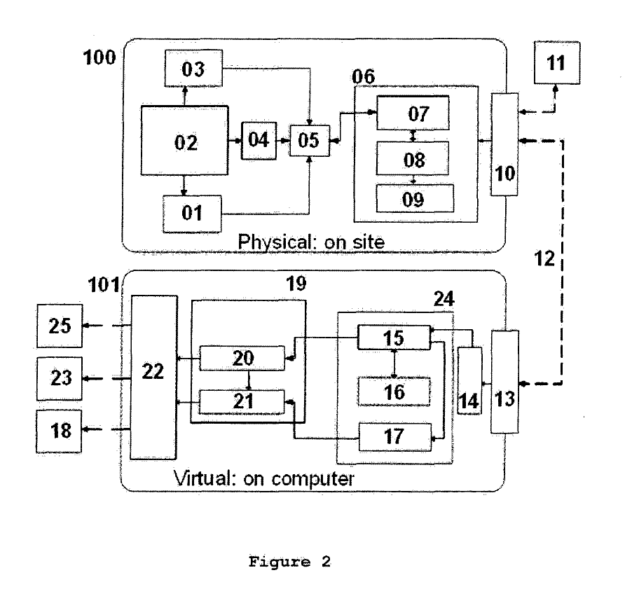

FIG. 2 is a detailed schematic representation of the structural health management system and method according with this invention, where:
100—represents a physical module on critical system, comprising:
   01—a sensor type (acceleration, strain)
   02—a structure to analyse
   03—a sensor type (temperature, humidity)
04—a sensor type (corrosion, thickness, other)
   05—an interface between the sensors and a data acquisition system
   06—a hardware platform, comprising
      07—a data acquisition system
      08—a sampling algorithm and signal processing tools
      09—a data storage device
      10—a data exchange assess port
12—represents a data transfer supported by a cable, wireless, portable data storage device connections.
101—represents a virtual module on computer, comprising:
   13—a data exchange assess port
   14—a data translation
   24—a representative virtual module, RVM, comprising:
      15—a solver
      16—an optimisation tool
      17—a database
   19—a decision module, comprising:
      20—diagnosis tool
      21—a prognosis tool
   22—an output layer (GUI)
11—an intervention of a maintenance technician
18—an intervention of a design analysts
23—an intervention of a maintenance analyst
25—an interface with other systems and analysts (logistics, maintenance, mission planning

### DETAILED DESCRIPTION OF THE INVENTION

Referring to FIG. 1 the structural health analysis system is defined by two modules: a physical module 100 and a virtual module 101.

The physical module is located in the critical system. The sensor network is placed on selected components/structures to monitor. The sensors network can be based on commercially off the shelf (COTS) components or on self-sensing materials. The sensors are connected to a data acquisition system (an additional one or supported by an already existing Flight-Data Acquisition Unit—FDUA, or a Supervisory Control and Data Acquisition system—SCADA). The virtual module is located in a computer. It can be placed in the critical system or in another location. A convenient data exchange scheme between the two modules is adopted (cable, wireless or a portable data storage device).

The structural health analysis system can work synchronously, where real and simulated data are combined immediately given the current health status selected of the components/structures. The structural health analysis system can work asynchronously, where real data are collected over a specified time interval (e.g., mission, operation period) and stored. Then, they are transfer to the virtual module, where they are combined with simulated data for giving the health status of selected components/structures.

Referring to FIG. 2 the structural health analysis system is defined by two modules: a physical module 100 and a virtual module 101.

The physical module 100 is materialized on a combination of sensors and a hardware platform. Sensors are installed in specific points of the component or structure 02. The procedure for selection of sensor location points is based on suitable optimization methodologies. Several types of sensors can be used to monitor different physical variables that can be used together or in other configurations. Sensor 01 set is for example defined by thermal probes for the evaluation of the thermal environment of the component. Sensor 03 set is for example defined by strain sensors placed on the structure enabling the local deformation analysis. Sensor 04 set is for example defined by accelerometers for analysing the vibration at specific locations. All sensors are wire or wireless connected to an interface 05 device for data fusion of physical sensors sets. The hardware 06 platform is a scalable platform with the ability to incorporate information from several monitored components and interact with other hardware devices. The hardware 06 platform comprises a signal acquisition system that is wire or wireless connected to the sensor interface 05 device, a configurable firmware 08 that manages the hardware platform defining the sampling pattern for data acquisition and performs signal processing operations on data gathered and a fast storage memory 09 to preserve the information. At this level, simple signal processing operations (e.g., averaging, filtering, time-to-frequency transforms, de-noising) are performed. Sensor fault detection techniques may also be performed at this level that issues warnings about sensor sanity. The hardware 06 platform data can be externally assessed using a data exchange device 10 that enables the interconnection using a portable storage devices or wire and wireless technologies 12.

The virtual module 101 is a computer application. The module comprises three main components a simulation Representative Virtual Model—RVM—24, a decision module 19 and an output graphical layer 22. The data obtained from the physical module 100, is an input load for the RVM 24. The module is interconnected using a portable storage devices or wire and wireless technologies 12 and the data is feed to the exchange device 13. The data is transformed through the data translator 14 into a suitable form for direct data input into RVM 24. Before inputting the RVM 24, sensor fault detection techniques are also applied that results in warnings issues about the sensor sanity or may even prevent further calculations. RVM 24 comprises three main elements: i) a numerical solver 15, based on advanced technologies for solving structural dynamics problems; the solver 15 can be based on an analytical or numerical solutions (e.g., Finite Element Method—FEM—, Finite Volume Method—FVM—, Boundary Element Method—BEM—or Meshless technologies); ii) An optimization tool 16 based on optimization methodologies; the optimization tool 16 will interact with solver 15 enabling procedures for earlier sensor placement and damage diagnosis; iii) A database 17 for storage and access of previous information on the systems. The database 17 will permit a starting point for upcoming analysis and a foundation for structure prognosis. The decision module 19 includes two main elements: i) A diagnosis tool 20 that is based on the stress and strain history and materials properties degradation models; the diagnosis tool is a mean to analyse the structural integrity of a component; ii) A prognosis tool 21 to predict the component future behaviour based on the previous RVM results; the information produced for diagnosis and prognosis for a candidate component or sub-structure can be visualized in an integrated graphical interface output layer 22. The field variables are mapped on the CAD geometry of the structure and the scalar quantities are graphically or numerically displayed, being both also presented in tabular form.

The method to apply the present invention as a structural integrity and health management tool is divided in two phases:

Phase 1: Is associated with design activities of the components/structure of the critical system. The RVM 24 is used by the structural engineer 18 to place optimally a set of sensors on the structure (2). The optimal location and sensor types will be applied to the component. The monitored components/structures are connected to the hardware platform 06 enabling the gathering of data under a predefined sampling pattern. RVM 24 is also integrated on the design process as a plug-in on the analysis tool enabling the analysis of different load scenarios. Structure health condition of the structure (2) can be input in the design analysis from historical, current or predicted data. The information from RVM 24 is also available for the design of new structures/components.
Phase 2: Is associated with operational usage of the structure. The monitored components/structures 02 and the hardware platform 06 are interconnected and during an operational period of the components the sampling algorithm 08 will trigger data gathering intervals, data is read by the data acquisition module 07 being perform signal processing operations 08 before storage for future analysis on the storage device 09. The sampling parameters can be specified by a maintenance technician 11. Periodically the information stored on the hardware platform 06 is feed to the computer application 101. The data is transformed into a suitable form and acts as an input for the RVM 24. RVM will reproduce virtually the mechanical status of the component based on the physical information gathered from with the hardware platform 06. The results from the virtual model will be stored on the database 17 and will be the foundation for mechanical integrity diagnosis 20 of the decision module 19. The prognosis sub-module 21 will use the history of RVM 24 solutions stored on the database 17 as a basis structural health forecast. The diagnosis and prognosis indicators can be displayed for the component in analysis mapped on its geometric representation on the output layer 22. These indicators can be used by the maintenance engineer 23 as a decision support tools for deciding the right schedule for intervention on the structure. For a priori defined maintenance program the maintenance engineer 23 will have a tool that can be used to redefine the intervention calendar and/or typology. The output layer 22 further interfaces with other systems 25. This may be supported by standard communication protocols such as OSA-CBM interface and ISO-13374.

The exemplary embodiment of the invention, as set forth above, are intended to be illustrative, not limiting. Having completed the description of the invention it is evident that several configuration changes can be made without departing from the scope thereof.

The following claims set out particular embodiments of the invention.

1. A system for managing structural health, based on combined physical and simulated integrity data, of a critical structure (2) comprising:
a. a physical module (100) placed in said structure (2), which comprises a sensor network (1, 3, 4) mounted or embedded in said structure (2), a hardware platform (6) comprising a data acquisition (7) and sampling and signal processing (8) sub-modules with multi-sensor capability, and an interface (5) to the hardware platform (6);
b. a virtual module (101), which comprises a simulated representative virtual model (24) of the structure (2) combined with a suitable solver (15) able to reproduce the behaviour of the structure (2), and its components, based on the physical information gathered from the physical module (100);
wherein said simulated model (24) was previously established when defining the optimal locations of said sensors.

2. A system according to claim 1 further comprising:
a. a data storage sub-module (9) in the physical module (100);
b. a database (17) in the virtual module (101) storing and managing data, real or simulated;
c. a decision sub-module (19) comprising diagnostics (20) and prognostics (21) sub-modules of the structure (2).

3. A system according to claim 1, wherein the sampling sub-module (8) will trigger data gathering intervals and data acquisition frequency, based on predefined values or on a sporadic but relevant event.

4. A system according to claim 1, wherein signal processing operations are able to be performed in the sampling sub-module (8), in particular averaging, filtering, time-to-frequency transforms, or de-noising.

5. A system according to claim 1, wherein the solver sub-module (15) comprises an analytical or a numerical solution through a metamodel approximation, a Finite Element Method—FEM, calculator, Finite Volume Method—FVM, calculator, Boundary Element Method—BEM, calculator, or a meshless structural calculator.

6. A system according to claim 1, wherein both physical (100) and virtual (101) modules are both mounted or embedded in said structure (2) and connected by a suitable data connection (12).

7. A system according to claim 1, wherein the virtual module (101) is mounted away from said structure (2), and connected to the physical (100) module by a suitable data connection (12).

8. A system according to claim 1, wherein the data connection (12) between the physical (100) and virtual (101) modules is asynchronous.

9. A system according to claim 1 further comprising an output layer sub-module (22), connected to the diagnostic (20) and prognostic (21) sub-modules on the integrity of the structure (2).

10. A system according to claim 1, wherein the simulated representative virtual model (24) of the structure (2) further comprises previously or regularly obtained interrogative procedure data.

11. A system according to claim 1 further comprising an interface for data exchange (10) with the exterior of the system.

12. A system according to claim 1, wherein the virtual module (101), comprises an interface for data exchange (13) with exterior, a data translation (14) tool.

13. A system according to claim 1, wherein the virtual module (101), comprises an optimization tool (16) able to support the damage diagnosis tool (20).

14. A system according to claim 1 further comprising the integrated and simultaneous management of the structural health of several structures/components of a critical system.

15. A system according to claim 1 further comprising the integrated and simultaneous management of the structural health of a set of critical systems.

16. A method for managing structure health based on combining physical and simulated integrity data of a critical structure (2) comprising the steps of:
a. acquiring (7), sampling and signal processing (8) physical integrity data from a plurality of sensors (1, 3, 4) mounted or embedded in the structure (2);
b. calculating and solving (15) a simulated representative virtual model (24) of the structure (2) reproducing the physical status of the structure (2), and its components;
c. combining real data from the two previous steps through an optimization algorithm for diagnosing—detecting, locating and evaluating the severity—of material or structure damage,
wherein said sensors (1, 3, 4) position was previously established by an optimization method,
wherein real sensor (1, 3, 4) responses are checked for sensor fault detection before being fed to the simulated virtual model (24),
wherein said simulated model (24) was previously established when defining the optimal locations of said sensors (1, 3, 4).

17. A method according to claim 16, wherein the sensor fault detection is performed in a physical module (100) at the data acquisition system level (17), or it is performed in a virtual module (101) at the data translation level (13), or in both physical and virtual modules (100) and (101), respectively.

18. A method according to claim 16, wherein the sensor (1, 2, 4) positioning on said structure (2) comprises any suitable optimization methodology that minimizes their number, whilst maximizing their sensing capability, being based on the simulated model (24) with a solver (15) representative of the material/structure.

19. A method according to claim 16, wherein the sensor placement optimises the response of the sensor network to excitation, over a range of frequencies, such that an entire, or the maximum, or a predefined set of vibration modes is captured.

20. A method according to claim 16 further comprising the steps of:
a. storing (9) the acquired (7) and sampled (8) data;
b. detecting sensor malfunctions and damages in the physical module (100) at the data acquisition level (7) or/and at the virtual module (101) at the data translation level (14), before inputting data into the RVM sub-module (24);
c. translating, to a suitable format for input into the simulated model (24), the acquired (7), sampled (8) and verified data;
d. determining diagnosis (20) and prognosis (21) of the structure (2) based on said simulated model (24);
e. outputting (22) said diagnostics (20) and prognostics (21) of the structure (2).

21-31. (canceled)
